(19) United States
(12) Patent Application Publication
(10) Pub. No.: US 2008/0199146 A1
(43) Pub. Date: Aug. 21, 2008

(54) STREAM REPRODUCTION APPARATUS AND STREAM REPRODUCTION METHOD

(75) Inventor: Kouji Shimotaka, Kawasaki (JP)

Correspondence Address: YOUNG & THOMPSON, 209 Madison Street, Suite 500, ALEXANDRIA, VA, 22314, US

(73) Assignee: NEC ELECTRONICS CORPORATION, KAWASAKI (JP)

(21) Appl. No.: 12/028,016

(22) Filed: Feb. 8, 2008

(30) Foreign Application Priority Data
Feb. 16, 2007 (JP) 2007-36783

(51) Int. Cl. G11B 27/00

(52) U.S. Cl. 386/54

(57) ABSTRACT

In order to accurately reproduce an operation performed by a user when debugging a data stream reproduction apparatus, a stream reproduction method according to the present invention obtains, during reproduction processing carried out by a reproduction apparatus with respect to a data stream, each time an instruction relating to the reproduction processing is input by a user, timing information indicating a timing of the reproduction processing carried out by the reproduction apparatus with respect to the data stream, and records the timing information in association with a content of the instruction, as an instruction log. The recording further includes recording, as the content of the instruction, a duration during which the instruction has lasted.

### BACKGROUND OF THE INVENTION

1. Field of the Invention

The present invention relates to reproduction of a data stream, and more particularly, to a technology of reproducing reproduction of a stream carried out by a reproduction apparatus.

2. Description of Related Art

In a case where a failure has occurred in a receiver for digital broadcasting or in an electronic device for reproducing a content recorded on a recording medium such as a digital versatile disc (DVD), debugging is performed in which the cause of the failure is tracked down by reproducing the situation in which the failure has occurred. In the debugging, it is necessary to accurately reproduce an operation actually performed by a user through an input part such as a remote control device (hereinafter, simply referred to as remote controller) or a key.

JP 2005-258573 A (hereinafter, referred to as Patent Document 1) discloses a technology in which an actual key operation performed by a user is recorded in association with a time at which the operation is performed, as a key record, and the recorded key record is read out, at the time of debugging, to reproduce a key operation exactly the same as the key record.

Also, JP 2003-046889 A (hereinafter, referred to as Patent Document 2) discloses a technology of recording, when a failure has occurred in a receiving device for digital broadcasting, a type of the failure or a status of a multiple stream, in association with an operation performed by a user at the time of the failure.

There may be a case where, when carrying out reproduction processing by a reproduction apparatus with respect to a digital content, the reproduction apparatus operates differently depending on a duration of an operation performed by a user. For example, with respect to an operation in which a “play” button is pressed for a short period of time, the reproduction apparatus performs reproduction at normal speed. On the other hand, with respect to an operation in which the “play” button is pressed for a long period of time (for example, for five seconds or more), the reproduction apparatus may carry out the reproduction at fast speed. In the case where the reproduction apparatus operates differently depending on a duration of an operation even when the same operation is performed, as described above, it is not possible to accurately reproduce an operation of a user at the time of debugging merely by recording the operation as disclosed in Patent Documents 1 and 2, leading to a fear that the debugging cannot be correctly performed.

### SUMMARY

An aspect of the present invention is a stream reproduction apparatus. The apparatus includes: a reproduction processing part for carrying out reproduction processing with respect to a data stream; an instruction input part for allowing a user to input therethrough, during the reproduction processing carried out by the reproduction processing part, an instruction relating to the reproduction processing; and an instruction log recording part for obtaining, each time the instruction is input through the instruction input part, timing information indicating a timing of the reproduction processing carried out by the reproduction processing part with respect to the data stream, and recording the timing information in association with a content of the instruction, as an instruction log. The instruction log recording part further records, as the content of the instruction, a duration during which the instruction has lasted.

Another aspect of the present invention is a stream reproduction method. The method includes: obtaining, during reproduction processing carried out by a reproduction apparatus with respect to a data stream, each time an instruction relating to the reproduction processing is input by a user, timing information indicating a timing of the reproduction processing carried out by the reproduction apparatus with respect to the data stream; and recording the timing information in association with a content of the instruction, as an instruction log. The recording further records, as the content of the instruction, a duration during which the instruction has lasted.

It should be noted that the above-mentioned aspects of the present invention can also be implemented as a system or a program.

According to the technology of the present invention, when debugging a data stream reproduction apparatus, it is possible to accurately reproduce an operation performed by a user.

### BRIEF DESCRIPTION OF THE DRAWINGS

In the accompanying drawings:

FIG. 1 is a diagram illustrating a receiver according to an embodiment of the present invention;

FIG. 2 is a diagram illustrating a multiple stream to be processed by the receiver shown in FIG. 1;

FIG. 3 is a diagram illustrating an example of an instruction log recorded by an instruction log recording part in the receiver shown in FIG. 1;

FIG. 4 is a flowchart illustrating a flow of a process performed by the instruction log recording part in the receiver shown in FIG. 1; and

FIG. 5 is a flowchart illustrating a flow of a process performed when a command issuing part operates as a reproduction control part in the receiver shown in FIG. 1.

### DETAILED DESCRIPTION OF PREFERRED EMBODIMENTS

Hereinbelow, an embodiment of the present invention will be described with reference to the accompanying drawings.

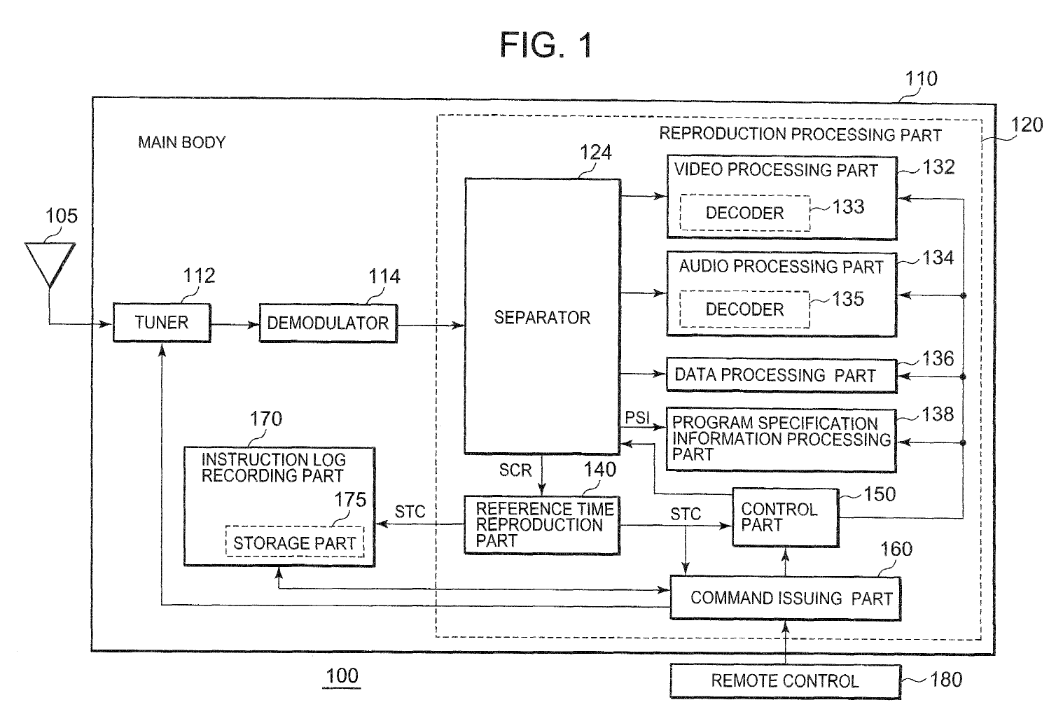

FIG. 1 illustrates a receiver 100 for digital broadcasting according to an embodiment of the present invention. The receiver 100 includes an antenna 105, a main body 110 of the receiver 100, and a remote controller 180 for performing an operation to provide an instruction to the main body 110. The main body 110 includes a tuner 112, a demodulator 114, a reproduction processing part 120, and an instruction log recording part 170. The reproduction processing part 120 includes a separator 124, a video processing part 132, an audio processing part 134, a data processing part 136, a program specification information processing part 138, a control part 150 for controlling those functional blocks, a reference time reproduction part 140, and a command issuing part 160 for issuing a command to the control part 150.

In FIG. 1, each of the elements described as the functional blocks for performing various processes can be implemented as a processor, a memory, or another LSI, in terms of hardware, or can be implemented, for example, as a program loaded into a memory, in terms of software. Accordingly, it should be appreciated by those skilled in the art that the functional blocks can be implemented in various ways, for example, only by using hardware or software or by a combination thereof, and the present invention is not limited to any one of those ways.

A broadcast wave received by the antenna 105 is input to the main body 110, more specifically, to the tuner 112. The broadcast wave includes signals from a plurality of broadcast channels, and the tuner 112 selects, from among the signals, a signal corresponding to a channel selected by a user and inputs the selected signal to the demodulator 114. The user selects a channel through the remote controller 180.

The demodulator 114 demodulates the signal input from the tuner 112 to an original data stream. The data stream refers to a multiple stream including a plurality of streams such as a video stream and an audio stream.

The following description will be given by taking, as an example, a case where the multiple stream obtained by the demodulator 114 is a transport stream (TS) conforming to MPEG-2.

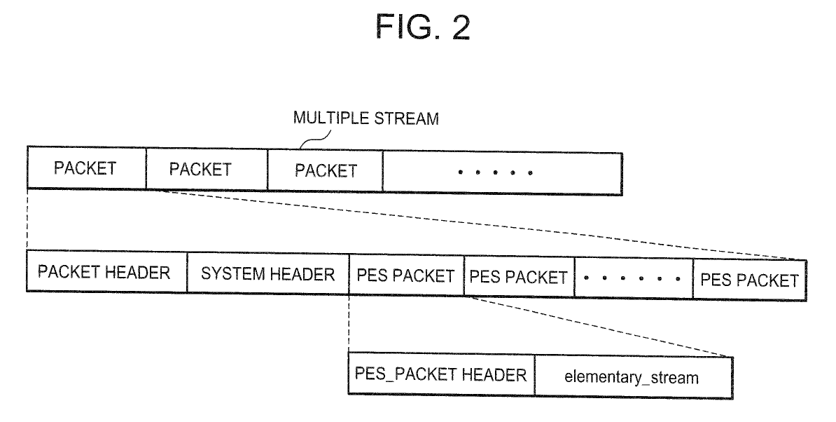

FIG. 2 shows a structure of the multiple stream TS obtained by the demodulator 114. The multiple stream includes packets generated from a video frame, an audio frame, and various additional data items. The packets each include a packet header, a system header, and a plurality of packetized elementary stream (PES: coded data of packetized video and audio) packets. The PES packets each further include a PES_packet header and an elementary stream (ES: coded data).

The reproduction processing part 120 carries out reproduction processing with respect to the TS shown in FIG. 2, which has been obtained by the demodulator 114. First, the separator 124 of the reproduction processing part 120 demultiplexes the multiple stream input from the demodulator 114 to obtain a video stream, an audio stream, data such as character data or static image data, program specification information, a system header, and a system clock reference (SCR), which are each output to the video processing part 132, the audio processing part 134, the data processing part 136, the program specification information processing part 138, the control part 150, and the reference time reproduction part 140, respectively.

In this case, the SCR input to the reference time reproduction part 140 includes timing information provided for synchronization between the video stream and the audio stream included in the multiple stream. The SCR is included in the packet header. According to MPEG-2, the SCR is expressed to an accuracy of 27 MHz, and the reference time reproduction part 140 reproduces the SCR as a reference time system reference time (STC) obtained at the time of encoding.

The program specification information input to the program specification information processing part 138 is also referred to as program specific information (PSI) The term “program” in this case refers to a content included in the multiple stream. The program specification information refers to data for various control information items, which includes information for decoding a program transmitted in the TS or an ES included in the program and further includes information for scrambling.

Data input to the data processing part 136 includes text data on subtitles provided to a video picture or static image data.

The video processing part 132 includes a decoder 133, and decodes the video stream output from the separator 124. The audio processing part 134 includes a decoder 135, and decodes the audio stream output from the separator 124.

Various data items processed by the video processing part 132, the audio processing part 134, the data processing part 136, and the program specification information processing part 138 are output to a synthesis part provided in a subsequent stage, which is not shown, and synthesized by the synthesis part to be output to an image display device (for example, a monitor) and an audio output device (for example, a speaker).

The control part 150 controls the video processing part 132, the audio processing part 134, the data processing part 136, and the program specific information processing part 138. The control part 150 performs a control process, which includes control for synchronization between the processes performed by those processing parts. The control part 150 controls the synchronization between various data processes, based on the STC input from the reference time reproduction part 140.

Also, in a case where an instruction has been input by a user through the remote controller 180 during the reproduction processing carried out by the reproduction processing part 120, the command issuing part 160 converts the instruction into a command and outputs the command to the control part 150, and the control part 150 performs control according to the command. The command issuing part 160 also operates, later at the time of debugging, as a reproduction control part for controlling reproduction of an operation performed by a user, which will be described later in detail.

The instruction log recording part 170 includes a storage part 175, and records, each time an instruction is given by a user through the remote controller 180 during the reproduction processing carried out by the reproduction processing part 120, the content of the instruction in association with timing information indicating a timing at which the reproduction processing part 120 carries out reproduction processing with respect to the multiple stream when the instruction is given, as an instruction log. The storage part 175 includes, for example, a flash memory or a hard disk.

The “timing information” indicates which part of the multiple stream is being processed during the processing, rather than indicating a time. In other words, the timing information includes information indicating which part, in the multiple stream, the reproduction processing part 120 is processing at the timing indicated by the timing information. According to this embodiment, the instruction log recording part 170 records, as the timing information, synchronous time information for synchronization between the streams in the multiple stream, that is, the STC obtained by the reference time reproduction part 140 in this case. Accordingly, the reference time reproduction part 140 inputs the STC reproduced based on the SCR obtained by the separator 124, not only to the control part 150 but also to the instruction log recording part 170.

Also, as described above, the instruction input by the user through the remote controller 180 is converted into a command by the command issuing part 160. The instruction log recording part 170 records the command obtained through the conversion performed by the command issuing part 160, on the storage part 175. Accordingly, the command issuing part 160 inputs the command not only to the control part 150 but also to the instruction log recording part 170.

Further, the instruction log recording part 170 also records, other than the command itself, a duration during which an instruction corresponding to the command has lasted, as a content of the instruction. For example, when a “play” button is pressed, a command converted as “a reproduction instruction” is recorded as well as a duration in time during which the “play” button is held pressed. It should be noted that, in this case, the duration may be recorded in units of seconds, for example, or may be recorded in any other form, as long as the duration can be specified from the recorded content. For example, a starting timing of the instruction and an ending timing of the instruction may be recorded in pairs. Also, for making the process more efficient, as regards an instruction for which the duration is recorded, the duration may be recorded only for an instruction that causes a reproduction apparatus to operate differently depending on the duration during which the instruction has lasted. An example of the instruction includes a “reproduction” instruction that instructs “normal reproduction” when the instruction lasts for a short period of time while instructing “double speed reproduction” when the instruction lasts for a long period of time Hereinafter, an instruction as described above is referred to as “target instruction” for which a duration thereof needs to be recorded.

Further, the instruction log recording part 170 also records identification information for identifying a multiple stream which is subjected to reproduction processing carried out by the reproduction processing part 120. The broadcast signals received by the antenna 105 include signals of multiple channels, and a user makes a selection through the remote controller 180 as to which one of the channels to receive. In other words, a channel for which a multiple stream thereof is subjected to the reproduction processing by the reproduction processing part 120 is selected by the user. According to this embodiment, information indicating a channel corresponds to the identification information for identifying a multiple stream, and a channel selection instruction provided by a user is converted into a command (channel information) by the command issuing part 160 to be input to the tuner 112 and also to the instruction log recording part 170. The instruction log recording part 170 also records the channel information on the storage part 175.

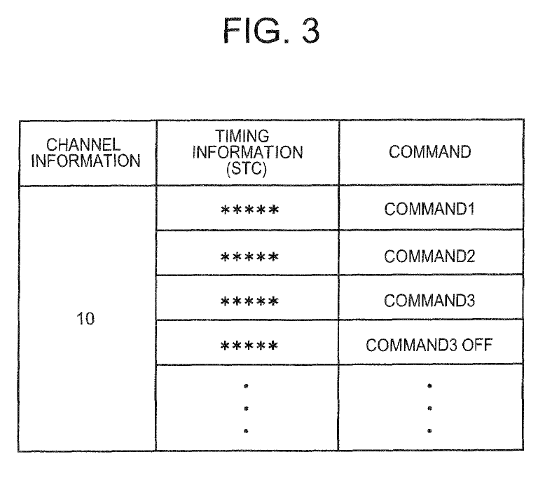

FIG. 3 illustrates an example of an instruction log recorded by the instruction log recording part 170. As shown in the drawing, the instruction log includes channel information which serves as identification information for specifying a multiple stream to be processed by the reproduction processing part 120, a command corresponding to an instruction provided by a user, and an STC corresponding to the timing information on a timing at which the instruction is provided. A command 3 corresponds to the target instruction, for which the duration thereof needs to be recorded, and therefore an STC at which the instruction is released (command 3 off) is also recorded with respect to the command 3.

The instruction log recorded as described above is used for investigating a failure at the time of debugging. As described above, the command issuing part 160 also operates, at the time of debugging, as the reproduction control part for controlling reproduction of an operation performed by a user. This embodiment is implemented as a receiver for digital broadcasting, and accordingly, at the time of debugging, a broadcast wave equivalent to that broadcasted in a period of time in which the failure to be investigated has occurred or a test stream for failure investigation is input to the receiver 100 from a broadcasting simulation system provided to a manufacturer or the like. The command issuing part 160 outputs channel information included in the instruction log recorded by the instruction log recording part 170, to the separator 124 through the control part 150, to thereby cause the separator 124 to reproduce the same channel as the channel reproduced at the time when the failure has occurred. Then, during the reproduction processing carried out by the reproduction processing part 120 with respect to the multiple stream corresponding to the channel obtained by the separator 124, when the STC obtained by the reference time reproduction part 140 coincides with the STC included in the instruction log recorded by the instruction log recording part 170, a command recorded in association with the STC is output to the control part 150. As regards a command corresponding to the target instruction, such as the command 3, the output of the command is continued during the duration thereof.

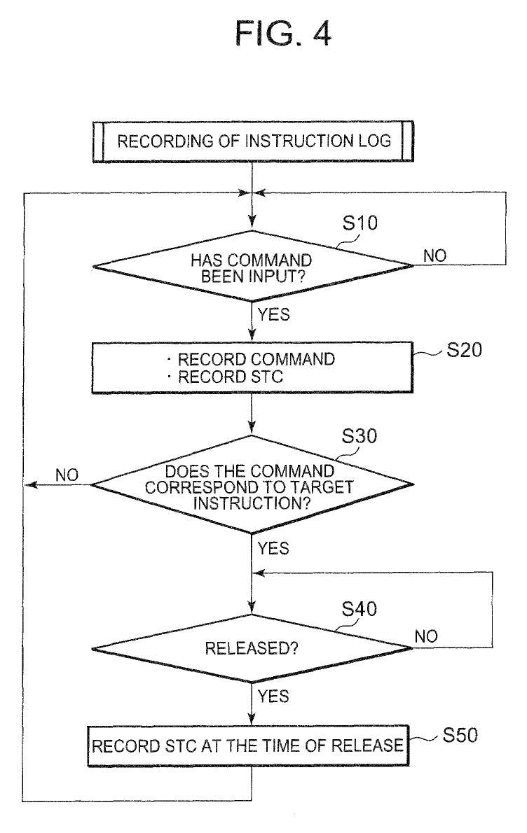

FIG. 4 is a flowchart for illustrating a flow of an operation performed by the instruction log recording part 170 during the reproduction processing carried out by the reproduction processing part 120, in the receiver 100. As shown in the drawing, when a command has been input from the command issuing part 160, that is, when a user has input an instruction through the remote controller 180 (S10: Yes), the instruction log recording part 170 records, together with the command, the STC input from the reference time reproduction part 140 at this time (S20).

Then, the instruction log recording part 170 determines whether the command corresponds or not to the target instruction that causes a reproduction processing part 120 to operate differently depending on the duration during which the instruction has lasted (S30). When the command does not correspond to the target instruction (S30: No), the instruction log recording part 170 waits until a next command is input. On the other hand, when the command corresponds to the target instruction, the instruction log recording part 170 records the STC at which the command is released (S30: Yes, S40: Yes, S50), and waits until a next command is input.

The channel information is recorded according to a selection instruction provided by a user when the receiver 100 starts a receiving operation.

To debug the receiver 100, the receiver 100 is switched to a debug mode by an external device, such as a computer, and a broadcast wave equivalent to that broadcasted in a period of time in which the failure to be investigated has occurred or a test stream for failure investigation is input to the receiver 100. In the debug mode, other functional blocks of the receiver 100 operate similarly as in the case of normal reception, except in that the instruction log recording part 170 does not record the instruction log and the command issuing part 160 operates as the reproduction control part, and therefore, a description will be given, in this case, merely of the reproduction control operation of the command issuing part 160.

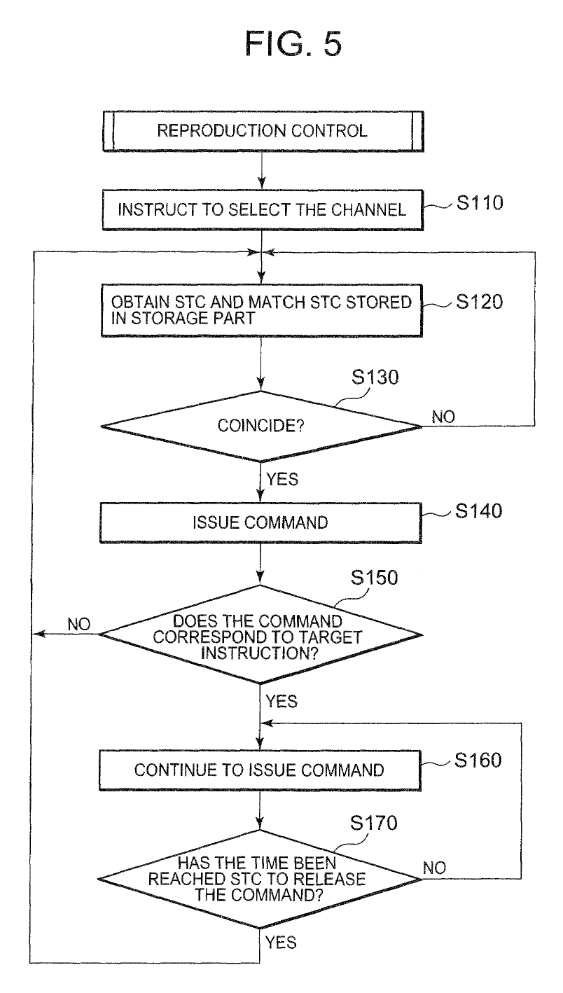

FIG. 5 is a flowchart illustrating a flow of the reproduction control performed by the command issuing part 160. First, upon starting the receiving operation, the command issuing part 160 outputs a channel selection instruction indicated by the channel information recorded on the storage part 175 of the instruction log recording part 170, to the separator 124 through the control part 150 so that the selected channel is reproduced (S110). Then, the command issuing part 160 obtains an STC output by the reference time reproduction part 140 along with the progress of the demodulation by the demodulator 114 and the reproduction processing carried out by the reproduction processing part 120 with respect to the multiple stream obtained by the demodulator 114, and compares the obtained STC with each of the STCs recorded on the storage part 175 (S120). When the storage part 175 does not include an STC that coincides with the obtained STC (S130: No), the command issuing part 160 continues the process of Step S120. On the other hand, when the storage part 175 includes an STC that coincides with the obtained STC (S130: Yes), a command recorded in association with the STC in the storage part 175 is issued to the command issuing part 160 (S140). Further, the command issuing part 160 determines whether or not the command corresponds to the target instruction (S150), and when the command does not correspond to the target instruction (S150: No), the process returns to Step S120. On the other hand, when the command corresponds to the target instruction (S150: Yes), the command is continued to be issued to the command issuing part 160 until the STC recorded in the instruction log is reached, at which the command should be released (S160, S170: No, S160, . . . ).

The STC to release the command corresponding to the target instruction is reached (S170: Yes). The command issuing part 160 stops issuing the command, and returns to Step S120.

As described above, according to the receiver 100 of this embodiment, during the reproduction processing carried out by the reproduction processing part 120, each time an instruction is provided by a user, an STC is obtained, as the timing information of the reproduction processing carried out by the reproduction processing part 120, with respect to the multiple stream which is being processed, and the STC is recorded in association with the content of the instruction, while the duration of an target instruction that causes the reproduction processing part 120 to operate differently depending on the duration of the instruction is also recorded. In this manner, at the time of debugging performed later on, it is possible to reproduce an operation performed by a user, with more accuracy, and to correctly perform the debugging, as compared with a conventional technology in which only an instruction is recorded without recording the duration of the instruction.

Further, a failure may occur during the reproduction processing of a stream, due to a bit rate of the stream or the like. When merely the time of an operation performed by a user is simply recorded as described in Patent Document 1, it is difficult during debugging to provide the same instruction as the instruction which has been given by the user, with respect to a portion of the stream to be processed which is the same as the portion which has been processed when the instruction has been given by the user, at the same timing, with the result that it is not possible to perform accurate reproduction. In contrast to this, according to the receiver 100 of this embodiment, the timing of the reproduction processing performed by the reproduction processing part 120, rather than a time, is recorded with respect to the stream being processed, it is possible during debugging to provide the same instruction as the instruction which has been given by a user, with respect to a portion of the stream to be processed which is the same as the portion which has been processed when the instruction has been given by the user, at the same timing, to thereby reproduce the operation of the user with accuracy.

As described above, the present invention has been described with reference to the embodiment. The embodiment is described by way of example, and may be subjected to various modifications and alterations without departing the gist of the present invention. It should be appreciated by those skilled in the art that modification examples thus modified and altered fall within the scope of the present invention.

For example, the receiver 100 according to the embodiment shown in FIG. 1 is implemented as a receiving apparatus for digital broadcasting to which the present invention is applied. However, the technology according to the present invention can also be applied to a device, such as a DVD player, for reproducing a content recorded on a recording medium.

Further, the technology according to the present invention can also be applied to a reproduction apparatus for reproducing, not only a multiple stream, but also a single data stream such as a video stream or an audio stream.

Also, in the receiver 100, for the purpose of reducing the circuit size of the apparatus, the command issuing part 160 also operates as the reproduction control part at the time of debugging. However, the reproduction control part may be provided independently of the command issuing part 160.

What is claimed is:

1. A stream reproduction apparatus, comprising:
a reproduction processing part that carries out reproduction processing based on a data stream; and
an instruction log recording part that records an instruction log, and a length of duration for activating an instruction.

2. A stream reproduction apparatus according to claim 1, wherein:
the data stream is a multiple stream; and
the instruction log recording part obtains, as a timing information, asynchronous time information for synchronization among some streams in the multiple stream.

3. A stream reproduction apparatus according to claim 1, further comprising:
a command conversion part that converts the instruction input through the instruction input part into a command and outputs the command to the reproduction processing part, wherein the instruction log recording part records the command output by the command conversion part, as the content of the instruction.

4. A stream reproduction apparatus according to claims 1, further comprising:
a duplication control part that duplicates the reproduction processing carried out by the reproduction processing part based on the data stream, wherein
when duplicates the reproduction processing, the duplication control part instructs, during the reproduction processing carried out by the reproduction processing part based on the data stream, the content of the instruction which is associated with the timing information to the reproduction processing part at a timing based on the timing information recorded in the instruction log recording part.

5. A stream reproduction apparatus according to claim 4, wherein the reproduction processing part processes a data stream selected from a plurality of data streams;
the instruction log recording part further records identification information of the data stream processed by the reproduction processing part when the instruction is input; and
the duplication control part causes the reproduction processing part to carry out the reproduction processing based on the data stream specified by the identification information recorded in the instruction log.

6. A stream reproduction method, comprising:
recording a instruction log and a length of duration for activating an instruction when reproduction processing carried out by a reproduction apparatus based on a data stream.

7. A stream reproduction method according to claim 6, further comprising:
obtaining, as a timing information, synchronous time information for synchronization among some streams in a multiple stream based on the data stream.

8. A stream reproduction method according to claim 6, further comprising:
duplicating the reproduction processing when reproducing the reproduction processing, during the reproduction processing carried out by the reproduction apparatus based on the data stream, the content of the instruction which is associated with the timing information to the reproduction apparatus at a timing based on the timing information recorded in the instruction log.
